(19) United States
(12) Patent Application Publication
(10) Pub. No.: US 2025/0311685 A1
(43) Pub. Date: Oct. 9, 2025

(54) METHOD AND DEVICE FOR OPTIMIZATION OF PLANT ROOT-ZONE TEMPERATURE

(71) Applicant: NOF- NATURAL OFFSET FARMING LTD, Lapid (IL)

(72) Inventor: Joseph HADASH, Lapid (IL)

(21) Appl. No.: 18/864,627

(22) PCT Filed: May 10, 2023
(86) PCT No.: PCT/IL2023/050475

§ 371 Date: Nov. 11, 2024

(30) Foreign Application Priority Data
May 12, 2022 (IL) 292980

(51) Int. Cl. A01G 29/00; A01G 7/02; A01G 25/06; A01G 25/16; F25B 9/00

(52) U.S. Cl. CPC A01G 29/00; A01G 7/02; A01G 25/06; A01G 25/16

(57) ABSTRACT

The invention provides a compact and self-sustained refrigeration system for agricultural uses, including in Vertical Farming. Greenhouses. LDS. Orchards. and home gardening uses, including in field extreme situations, in post-Harvest uses and in Aquaculture including Algae Farming, independent of external power supply, fueled by small amounts of liquid carbon dioxide.

### FIELD OF THE INVENTION

The present invention relates to a method and a system for controlling the root-zone temperature of plants. Particularly, the invention provides a compact device for the accumulation of chill hours in the roots by delivering temperature-controlled streams of fluid through the irrigation systems, bringing modern farming one step closer to being optimized in the fields, and orchards, in vertical farming, greenhouses, detached bedding farming, and even in home gardening use, including for autonomous field-uses without external power supply.

### BACKGROUND OF THE INVENTION

Climate changes and global warming are worldwide concern. Agriculture and climate change are internally correlated with each other in various aspects. For instance, land and farming are being affected by temperature changes and the plant's ability to accumulate their chill requirements naturally. All living things have some biological clock. For humans, it's the fatigue we feel daily, signaling that it's time to sleep (or to go “dormant”). For plants, dormancy signals the preparation of soft tissues for extreme weather shifts. Instead of exerting energy to grow, plants stop the growing processes and conserve energy until mild weather returns. This period of arrested growth allows roots to continue developing and thriving. In farming, certain chemicals are commonly used to break, artificially, plant dormancy. Chill requirements refer to growing flowers and fruits through a phase of cold treatment. There is a list of general chill requirements for different fruits and vegetables. (One chilling unit—for every full hour at temperatures below 7° C. (45° F.)). Unfortunately, the deficits in plant chilling units could directly or indirectly impact the production and quality of fresh fruits, vegetables, and other crops. They perform poorly in unpredictable behavior due to climate abnormalities influencing plant growth, flowering, fruit set, ripening, and product quality.

Root-zone temperature control has long been an integral part of maximizing yields in high-value crops. Studies have shown that regulating root temperature can ameliorate the effects of sub-optimal air temperatures, increase water transport from the rhizosphere to the leaves, increase stomatal conductance, and increase the dry shoot weight, leaf area, and fruit development. These benefits, looking at root zone temperature, as any other environmental factor, but keeping root temperatures in an ideal zone can also promote an environment where beneficial microbes can flourish. The benefits of root-zone temperature control, having robust beneficial biology, particularly in the root zone.

The root zone temperatures have performed well for different crops. Then, a decision can be made about the best strategy for controlling the root zone temperature. Therefore, a solution for quickly accumulating the cooling effects at the root is a tremendous agronomic advantage that may help solve global warming problems and relates to crops' type, quantity, and quality.

The relevant potential use of such device can be divided into two:
1. Agriculture of detached substrates (vertical farming). The world population suffers from the unavailability of fresh vegetables and fruits in densely populated areas.
2. Traditional agriculture, using drip irrigation, of farming with vegetables and fruits—The agricultural production in the world suffers because of global warming from a decline in crops and their quantity and quality.

Today, these farming activities are almost entirely dominated by traditional growing methods that rely on accumulating chill hours resulting from natural temperature changes in the winter. In fully organic farming, using chemicals to break the plant's dormancy is unacceptable. It is a general trend in agricultural farms to replace chemical treatments with non-chemical treatment that reduces farming costs, increases crops, improves quality, and reduces product waists.

Therefore, a solution is required to enable the farming sector to follow the fresh fruit and vegetable market trends: A focus on health and longevity, the popularity of pure and organic, search for fresh and new, sustainability, locally grown fresh, focus on food as medicine, convenience food, retail success determined by quality.

Moreover, carbon dioxide (CO2) as a refrigerant can be beneficial because of its energy costs, good thermodynamic properties, and low environmental impact. Food security and ecosystem resilience are the most concerning subjects worldwide. The threat of varying global climates has dramatically driven the attention of scientists. These variations negatively impact global crop production and compromise food security worldwide. According to some predicted reports, agriculture is considered the most endangered activity adversely affected by climate change. Climate-smart agriculture is the only way to lower the negative impact of climate variations on crop adaptation before drastically affecting global crop production.

It is an object of the present invention to provide a compact and accessible device that can lower the temperature of the plant's root zone in such immediate and accurate proximity of time.

It is another object of the present invention to provide a device capable of directing temperature-controlled air streams to the root zone of plants.

It is yet another object of the present invention to provide a device capable of controlling plants' root-zone temperature through the existing irrigation infrastructure.

Another object of this invention is to provide an autonomous method and device for cooling relatively small volumes and water for aquaculture without external power or a coolant supply.

It is a further object of this invention to provide a relatively compact cooling device for cold-water fish farming (salmon, tuna, cod, trout halibut, and more), including for autonomous field uses without external power or coolant supply.

It is still another object of this invention to provide a closed, compact, and self-sustained refrigeration system for cooling relatively small volumes or areas or producing relatively small streams of cooled fluid for harvest in fish farms.

It is a further object of the invention to provide a compact and robust device for aquafarming uses, including autonomous field uses.

It is yet a further object of the invention to provide a method for bringing the roots-zone volumes to the desired temperature for the acumination of chills hours required, immediately when needed.

It is also an object of this invention to provide a simple autonomous system for supplying a stream of fluid to the farming constructions (e.g., greenhouses, tunnels, containers, etc.) for cooling/heating them to the desired temperature.

Other objects and advantages of the present invention will appear as the description proceeds.

### SUMMARY OF THE INVENTION

The present invention relates to an autonomous device providing a stream of fluid employing liquid carbon dioxide (CO2) as a coolant. According to an embodiment of the invention, the autonomous cooling device can operate without an external power supply. In one aspect, the present invention relates to a device for optimizing the temperature of plants' root zone by generating and delivering controlled streams of fluids via an irrigation system.

In one aspect, the device comprises the following elements:
a pressurized chamber for containing liquid CO2;
an expansion chamber adapted for receiving an amount of liquid CO2 from said pressurized chamber;
1 a first valve for releasing an amount of CO2 from said pressurized chamber to said expansion chamber, via micro circumferential nuzzles;
a heat exchanger chamber in heat conductive contact with said pressurized and expansion chamber, for cooling fluid received therein, wherein said heat exchanger chamber provided with an inlet and a first outlet; and
a first pump for pumping said fluid through said heat exchange chamber.

In another aspect, the device further comprises a processing unit adapted to receive measurements indicative of the temperature of the root zone surrounding an irrigation dripper's outlet. According to an embodiment of the invention, the measurements are received from one or more sensors adapted to measure the temperature at the roots zone.

In another aspect, the device further comprises a flow rate sensor adapted for measuring the flow rate of the fluid at the first outlet.

In one aspect, a gaseous CO₂ exhausted from the expansion chamber is directed into a compressor unit for liquidation and recycled as liquid CO2 into the pressurized chamber. In another aspect, the device further comprises an interface for connecting the heat exchanger chamber to the irrigation system thru the first outlet, wherein a water opening of the irrigation system is suitable to be coupled to an add-on chamber that contains a unit, which is a type of vortex tube, the unit containing a second valve for controlling the water temperature.

In one aspect, the processing unit comprises stored data and suitable software configured for receiving information signals from the one or more sensors, sending instruction signals at least to the releasing and said controlling valves and to the pump, and receiving instructions from an operation board. According to some embodiments of the invention, the operation board is configured to regulate the temperature and the flow rate at the first outlet.

In another aspect, the device further comprises a battery or other internal energy source suitable for powering the elements of said device.

In another aspect, the device further comprises a heat-insulating enclosure for housing the elements of said device.

In another aspect, the device further comprises a switch for activating the cooling activity of the device.

In one aspect, the amount of liquid CO2 expands via micro circumferential nuzzles and forms solid CO2 and gas CO2, wherein said solid CO2 subliming and further cooling the heat exchanger and the fluid, while a recycling unit absorbs said CO2, wherein the first releasing valve is managed by said processing unit and repeatedly releases amounts of liquid CO2 to keep the temperature and the flowrate at the first outlet at predetermined values.

According to an embodiment of the invention, a connecting irrigation valve is managed by the processing unit and repeatedly releases amounts of irrigation water to keep the temperature and the flow rate at the irrigation dripper's outlet at predetermined values.

In one aspect, the fluid circulates in a closed and/or open circuit while cooling when flowing from the outlet to the inlet, aquaculture pools, or containers containing live aquacultural items. According to an embodiment of the invention, the fluid has a temperature within the range of: −75° C. and 0° C., and the flow rate at a second outlet is between 0.1 and 100 l/min, wherein the second outlet is the irrigation drippers outlet.

In one aspect, the device is a compact, robust, easily scalable, and autonomously working temperature controlling device, efficient for agricultural applications selected from the group consisting of: fields and orchards, greenhouses and vertical farming, at home, or under complex field conditions.

In a further aspect, the device is stable on prolonged storage, and is adapted to supply a fluid stream of a predetermined, precisely controlled temperature at any degree centigrade, immediately when needed. According to an embodiment of the invention, the generated stream has a predetermined temperature of between −70° C. and +35° C. and a magnitude of up to 100 l/min.

In one aspect, the heat exchanger is made of a heat-conductive material and is filled with a heat-conductive mesh made of a fine wire, and the device may comprise replaceable and/or disposable parts/elements.

In one aspect, an enclosure of said device has a well-isolated body suitable for implementing efficient farming temperature-controlling tasks.

In yet another aspect, the present invention relates to a method for providing a stream of cool air and warm irrigation water for cooling or warming the root zone of plants to a precisely regulated controlled temperature of the root zone for acumination of chill hours and enhance root activity, immediately when needed, according to the farming timeline without employing a closed refrigeration cycle, comprising:
providing a device having a first chamber adapted to store an amount of liquid CO2 in a pressurized form, expanding said liquid CO2 to a second chamber via a microvalve and micro circumferential nuzzles, and driving by a pump said expanded liquid CO2 to be cooled through a third chamber having an inlet and a first outlet;
receiving, from at least one sensor, readings indicative of the temperature of plant roots-zone at a farming substrate; and
processing, by a processing unit, said received readings, and accordingly providing commands to said microvalve and said pump to enable the delivery of streams of fluid for cooling the roots-zone of plants.

In one aspect, the method further comprises a fourth chamber adapted for driving by irrigation water line pressure to be warmed through and temperature regulated with the inlet and the first outlet of the third chamber.

In yet another aspect, the processing unit sends commands at least to the microvalve and the pump to generate and deliver fluid for cooling the root zone or warming the irrigation water for direct control of the root-zone temperature. According to an embodiment of the invention, the cooling is performed once during an interrupted event or several times during separate independent events, comprising starting and ending the cooling activity at different times according to the accumulation need of chill hours.

In one aspect, the method further comprises raising the temperature of said root zone from ambient temperature by 2-20° C., and the stream of the fluid, when being irrigation water, has a magnitude of between 0.1-100 l/min.

In yet another aspect, the present invention relates to a temperature control system for aquaculture, operating without a closed refrigeration cycle, comprising:
at least four chambers, a first chamber adapted for storing pressurized liquid CO₂, a second chamber adapted for enabling the expansion of said pressurized liquid CO2 via a micro circumferential nozzle of a microvalve, a third chamber adapted for driving, by a blower, said fluid to be cooled through with an inlet and outlet, and a fourth chamber driving by water supply line pressure to be warmed through and temperature regulated with said inlet and outlet;
one or more sensors adapted to measure the temperature of aquaculture water; and
a processing unit configured to receive data indicative of temperature measurements from said one or more sensors and accordingly to send operating commands at least to said microvalve and said blower, thereby providing a fluid for cooling aquaculture water or warming the aquaculture water for direct control of the aquaculture water temperature, wherein the cooling may be performed once during an interrupted event or more times during several separate independent events, wherein said system starts and ends the cooling activity at different times according to the need of the specific aquaculture production, while raising the temperature of said aquaculture water from ambient temperature by 2-20° C., and the stream of said fluid when being aquaculture water, may have a magnitude of between 0.1-100 l/min.

In one aspect, the temperature control system for aquaculture includes Algae Farming.

In yet another aspect, the present invention relates to a method for providing a stream of cool air and CO2 gas for cooling and or disinfecting the agricultural yield products to precisely regulated-controlled temperatures of the products (e.g., fruits, vegetables and flowers), for extending the shelf life by precooling the products and enhance resistance to pathogens, immediately in the harvesting process in the harvesting boxes/palettes, according to the harvesting timeline without employing a closed refrigeration cycle, and without external power supply, comprising:
providing at least four chambers, one: with an amount of liquid CO₂, expanding said liquid CO2 to a second chamber: via a micro circumferential nozzle, a said third chamber: driving by a blower said air to be cooled through with a said inlet and outlet; a said fourth chamber driving by cold air line pressure to the layers of harvested products through and temperature regulated with said inlet and outlet;
measuring by a sensor the temperature of said harvested products; and providing a microprocessor with data and software, receiving signals at least from said sensor, and sending instructions at least to said valve and said blower, thereby providing cold air for cooling said harvested products and/or providing CO2 treatment to said harvested products for direct control of said harvested products temperature, wherein the cooling may be performed once during an interrupted event or more times during several separate independent events, comprising starting and ending the cooling activity at different times according to the need of the chill treatment acumination, while reducing the temperature of said harvested products from ambient temperature by 2-20° C., and the stream of said fluid when being cold air, may have a magnitude of between 0.1-100 l/min.

All the above description has been provided for the purpose of illustration and is not meant to limit the invention in any way.

### BRIEF DESCRIPTION OF THE DRAWINGS

The above and other characteristics and advantages of the invention will be more readily apparent through the following examples and with reference to the appended drawings, wherein:

FIG. 1 schematically illustrates a device for optimizing plant root-zone temperature, according to an embodiment of the invention;

FIG. 2 schematically illustrates a device for optimizing plant root-zone temperature that comprises an add-on unit adapted to control the irrigation water temperature to optimize the root-zone temperature, according to an embodiment of the invention;

FIG. 3 schematically illustrates a transparent view of a device for optimizing plant root-zone temperature, according to an embodiment of the invention; and

FIG. 4 schematically illustrates the device of FIG. 1 in a farming Vernalization system implementation, according to an embodiment of the invention.

### DETAILED DESCRIPTION OF THE INVENTION

The present invention provides a solution for accumulating the deficits in plants' chill requirements by providing a temperature-controlled air stream through the existing irrigation infrastructure. According to an embodiment of the invention, cold airflow is directed to the plant roots at low temperatures through drippers hidden in the substrate. The temperature of the plant roots quickly drops, and the accumulation of chill hours by the plant begins. Thus, helping and controlling the cellular differentiation and flowering process. The structure and way of operation of the device are based on ambient air flowing through heat exchangers cooled by a cooling core into the lines of irrigation pipes and from there to the roots-zone.

According to an embodiment of the invention, the cooling is carried out by a controlled endo-thermal reaction of CO2 gas expansion and solid CO2 sublimation. Several technological components are innovative for this device:
The combination of air cooling with its flowing in the existing irrigation infrastructure differentiates the device in terms of efficiency by lowering the temperature of the plant's roots;
The device is configured to reduce the ambient air temperature in seconds.
The device is a plug-in design and relatively small in size, thanks to the energy source (compressed liquid CO₂) being stored in the device; and
It is entirely adjustable to the agricultural crop's type and variety by measuring the cooling effect on the root system.

It has been found that a relatively small container of liquid carbon dioxide can supply enough cool energy in a compact device for autonomous and controllable cooling of plants' roots-zone even under field conditions.

The existing cooling systems either include complex equipment employing the refrigeration cycle (also called the heat pump cycle) or use dormancy-breaking chemicals. Such existing systems use a working coolant that changes temperature and its phase from a condensed phase to gas and back during one closed refrigeration cycle. The cycle periodically repeats itself, requiring a continual external power input. The latter systems, using a static coolant precooled to a constant low temperature, are unreliable and difficult to control and plan, and they cannot be stored for future applications without external power output.

The invention provides a system that can work autonomously without external power or coolant supply, while being compact, robust, easily scalable, well regulated, easily stored for any future use, and flexibly and precisely managed for agricultural needs even under the most complex field conditions. In contrast to the existing systems, the invention employs phase transitions without a closed refrigeration (heat pump) cycle.

To provide a refrigeration system for plant roots-zone cooling uses, this invention employs liquid carbon dioxide (CO2) in a low-cost refrigerating device that is compact and simple in structure, exhibiting a smaller size and having fewer components than known cooling devices, resulting in fast and controllable performance, enabling easy operation and avoiding complex maintenance, and importantly capable of providing a predetermined temperature.

According to the invention, the device's structure enables scaling down and scaling up to all practically needed outputs. On the lower side of the device volume, volumes of down to 100 ml and up to 100000 ml can be manufactured according to the invention, such as devices having total outer volumes of 10000 ml or less, for example, 6000 ml, such as 5000 ml or 4000 ml or 3000 ml or 2000 ml or 1000 ml.

The method does enable mini-cooling, and the device may be employed as a mini-roots-zone machine when needed. On the upper side of the device volume, volumes above 100000 ml can be manufactured according to the invention, such as devices having total outer volumes of 12000 ml or more, for example, 15000 ml, such as 20000 ml or 40000 ml or more.

In many embodiments of the invention, liquid CO2 takes between 2% and 25% of the device volume, such as between 3% and 20% or between 4% and 15%, for example, about 10%. In one embodiment, the invention provides a cooling device of a volume of up to 10 liters, such as up to five liters, for example, up to three liters or up to two liters or up to one liter, ready to work after unlimited storage and to be used whenever needed, autonomously and without external power supply.

According to the invention, the controllable device can provide coolant fluid, either gas or liquid, for direct use in farming or for further heat transfer from cooled objects. The cool fluid may have a temperature of 0° C., cooling an aquaculture item such as pool containers or boxes, Algae Farming, etc.

The CO2 refrigerating device of the invention supplies cold fluid shortly after being activated (less than a minute, for example, less than 30 seconds) to the outlets that can be connected for any refrigeration of roots-zoon needs.

The device of the present invention employs a refrigeration cycle in which a part of CO2, liquified at pressures higher than about 76 atm and stably included in the storage space of the device, is controllably released to the expanding space of the device, thereby being converted to solid (dry ice) CO2 having a temperature of around −78° C., wherein the solid undergoes sublimation, thereby further cooling (while absorbing latent heat of sublimation) the said walls of said the expanding space and the storage space which are in contact with the said heat exchanger, through which a fluid to be cooled flows and is cooled. The cooled fluid is directly used or is employed for further heat transfer from another cooled streaming medium. The heat exchanger is made of a heat-conductive material, and it comprises fine structures to increase the heat-exchanging surface; the structures possibly comprise a mesh made of a fine wire, crumpled and compressed into the volume of the heat exchanger, enabling good heat flow out of the exchanger and good fluid flow through the exchanger. The mesh may comprise wire or fibers of copper, aluminum, graphite, or graphene, for example, copper wires 0.05-0.1 mm in thickness, arranged in a mesh having openings of, for example, 1-40 mesh (1-40 openings per inch). The whole volume of the mesh is conductively connected with the outer surface of the heat exchanger, which is cooled by the carbon dioxide; the cooling carbon dioxide may be in direct contact with the outer surface of the heat exchanger, or it may be enclosed within conductive envelope surrounding the expansion space. The fine mesh or net is preferably formed from thin, flexible conductive materials, acting as a turbulence generator and heat exchanger.

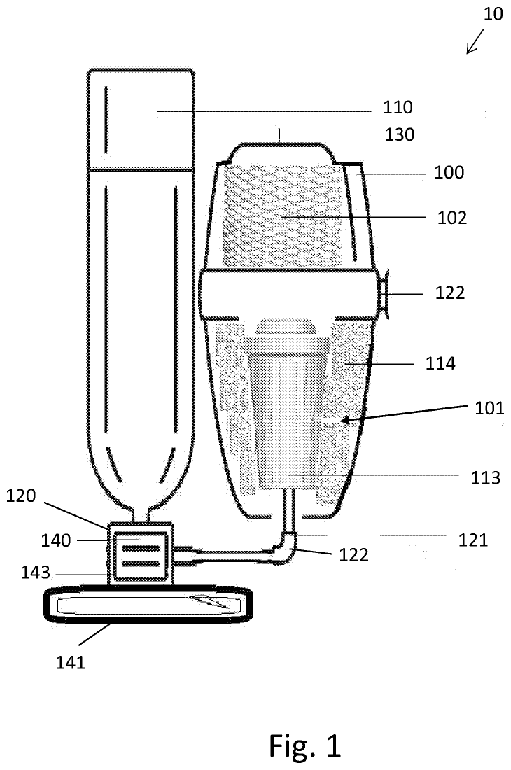

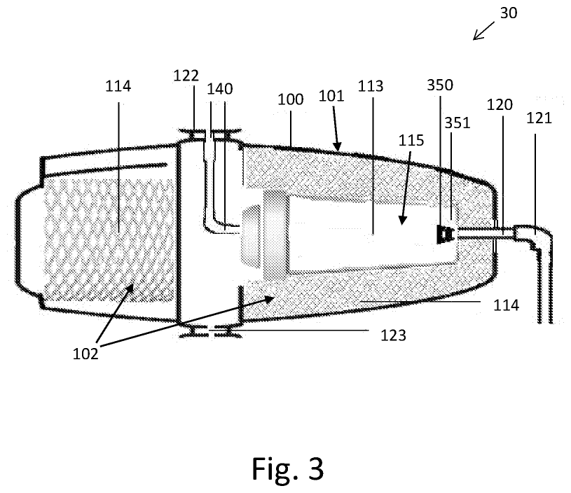

FIG. 1 schematically illustrates a device (10) for optimizing plant root-zone temperature, according to an embodiment of the invention. Device (10) comprises a well-isolated body (100), and a refrigeration chamber (101) constituting a heat exchanger. The refrigeration chamber (101) comprises a fine conductive net/mesh (114), in one embodiment in its whole volume, possibly in the form of a cylindrical roll, an ambient airflow chamber (102), a liquid CO2 container (110), possibly replaceable, a receiving unit (113) constituting the expanding space (the expanding space is indicated by numeral 115 in FIG. 3), an electromechanical microvalve (120), a discharge valve (122) of electromechanical microvalve (120) located at the end of a connecting pipe (121), a single or double outlet (122), a single or double fluid (air/gas or liquid) pump (130), an operational switch and operation electronic board (140), a possibly rechargeable battery (141), and an activating/operational button/switch (143).

According to an embodiment of the invention, device (10) comprises the following:
a pressurized chamber for containing liquid CO2;
an expansion chamber for accepting an amount of liquid CO2 from the pressurized chamber;
a valve for releasing an amount of CO2 from said pressurized chamber to said expansion chamber;
a heat exchanger chamber in heat conductive contact with said valve and expansion chamber, for accepting a fluid (either gas or liquid) to be cooled, provided with a first inlet and a first outlet;
a pump for pumping said fluid through said heat exchange chamber;
a first temperature sensor measuring the temperature of said roots-zone at said plants;
a first flowrate sensor measuring the flowrate of said fluid at the first outlet;
a CO2 liquidation unit containing a compressor for liquidating the exhausted gaseous CO2 and being in liquid contact with the pressurized chamber;
a microprocessor unit comprising stored data and suitable software, receiving information signals at least from said sensors and sending instruction signals at least to said releasing valve and to the pump, and receiving instructions from the operation board;
a battery for supplying energy to at least said valve, pump, compressor, sensors, and microprocessor;
a heat-insulating outer coat for containing the above device elements;
an operation board for regulating the temperature and the flowrate at the first outlet; and a switch for manually starting the temperature-controlling activity of the device.

FIG. 3 schematically illustrates a transparent view of a device 30 for optimizing plant root-zone temperature, according to an embodiment of the invention. In this embodiment, device 30 comprises a well-isolated body (100), a refrigeration chamber (101) constituting a heat exchanger (102), the refrigeration chamber (101) comprises a fine conductive net/mesh (114), in its whole volume, an ambient airflow chamber (102), a receiving unit (113) constituting the expanding space (115), a pipe (121) is adapted to be connected at one end to an electromechanical microvalve such as microvalve (120) shown in FIG. 1, and at the other end pipe (121) is connected to a discharge nozzle (350) at the end of the connecting pipe (121), with a conic discharge expanding space (115), for spinning of the CO2 molecules, (351), expending to a closed discharge space (115) within receiving unit (113), a fluid inlet (123), a fluid outlet (122), a gaseous CO₂ exhaust outlet (140).

By initiating the releasing valve and the pump, the amount of liquid CO2 expands and forms solid CO2 and gas CO2. The solid CO2 subliming further cools the heat exchanger and the fluid, while the CO2 liquidation unit absorbs the gaseous CO2. The processing unit can manage the releasing valve and repeatedly releases amounts of liquid CO2 to keep the temperature and the flow rate at the first outlet at predetermined values.

According to some embodiment of the invention, the cooled fluid in device (10) is water circulating in a closed circuit while cooling when flowing from the outlet to the inlet, an aquaculture basin, or an aquafarming box containing fish and/or seafood items.

According to an embodiment of the invention, the cooled fluid is air, and device (10) further comprises a second pump (not shown), and a mixing chamber (not shown) provided with a second inlet, a third inlet, and a second outlet, the second inlet receiving a first stream of cold air from the heat exchanger chamber via the first outlet, the first stream is driven by the first pump, the third inlet receiving a second stream of ambient, warmer air, driven by the second pump, and the second outlet releasing a third stream of mixed cold air for desired cooling activity. The warmer air either comes separately from outside or from the first inlet if it is split and supplies both the first and the second stream. In this embodiment, the stream of cool fluid is provided without using an external power supply (i.e., by using an internal power source, such as a battery or rechargeable battery).

According to an embodiment of the invention, the device comprises one or more liquefying units, each unit containing a compressor for absorbing gaseous CO₂ from the expansion chamber and liquefying it before its entrance to the pressurized chamber and to the expansion chamber. If the first inlet is split, one unit can liquefy both streams before they are split, and if the first inlet is not split, two compressor units may liquefy independently each one of the streams.

According to an embodiment of the invention, one or more temperature sensors are used for measuring the temperature of the root system at the root area or the drippers' outlet. According to an embodiment of the invention, an optional temperature sensor can be used for measuring the temperature of the fluid at the second farming position. The microprocessor unit receives data indicative of measured temperature (or other information signals) from all sensors, and sends operating commands to the valve and the pumps, thereby ensuring a suitable ratio between the first and the second flow rates, and thus the desired temperature and flowrate at the second outlet.

According to an embodiment of the invention, the device generates a stream of temperature-controlled fluid in the range of −75° C. to +25° C. (for example, a temperature between −75° C. and 0° C.). The predetermined flow rate at said second outlet may be between 0.1 and 1000 l/min.

According to an embodiment of the invention, the device is a compact, robust, easily scalable, and autonomously working cooling device, efficient for farming applications in fields, orchards, greenhouses, vertical farming, home use, and applications under complex field conditions. According to some embodiments of the invention, the device is suitable for farming and research applications at any site, as it does without external power or a coolant supply. The autonomous cooling device of the invention is stable on prolonged activation. It can be used when needed, immediately supplying a fluid stream of a predetermined, precisely controlled temperature.

For example, the device may provide an air stream having a predetermined temperature of between −75° C. and +25° C. and a magnitude of up to 1000 l/min. According to an embodiment of the invention, the device's heat exchanger is made of a heat-conductive material and may be filled with a heat-conductive mesh made of a fine wire.

According to an embodiment of the invention, the device may comprise replaceable and/or disposable parts/elements. Moreover, the device may be a compact and light apparatus for limited roots-zone volumes, having a volume of merely between 0.1 to 10 liters.

According to an embodiment of the invention, the device enables to provide a stream of fluid for cooling a roots-zone of the plants for the vernalization process (e.g., fields, orchards, greenhouses, vertical farming, or home gardening, etc.) to a precisely regulated low temperature immediately when needed, without employing a closed refrigeration cycle.

The process of providing a stream of cooled fluid may involve the use of at least three chambers within device (10). A first chamber is adapted for stringing an amount of pressurized liquid CO₂, a second chamber adapted for expanding the pressurized liquid CO2 via a microvalve (e.g., microvalve 120), and a third chamber for driving by a pump said fluid to be cooled through an outlet of the third chamber.

According to an embodiment of the invention, this process may involve receiving, from at least one sensor, readings indicative of the temperature of farmed plants' roots-zone at a farming substrate; and processing, by a processing unit, said received readings, and accordingly providing commands to said valve and said pump to enable the delivery of streams of fluid for cooling the roots-zone of plants, wherein the cooling may be performed at least once during an interrupted event or several times during separate independent events. The starting and ending of a cooling activity at different times or sites according to the need, while lowering the temperature of said roots-zone, for chill hours accumulation, from ambient temperature by 5-30° C., and the stream of said fluid when being air, may have a magnitude of between 0.1-1000 l/min.

According to an embodiment of the invention, device (10) may send data to a remote unit (e.g., cloud computing), for further processing and/or for enabling to inspect the data (e.g., by professional teams, farmer-owners, etc.).

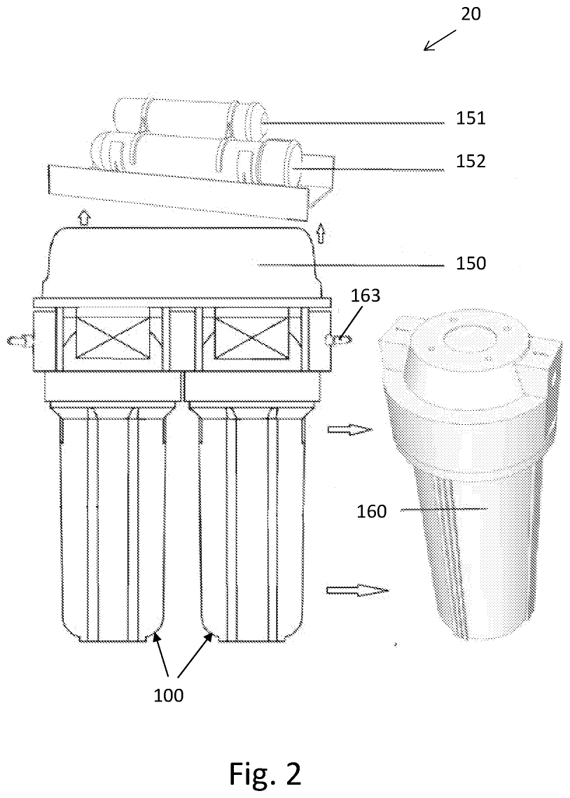

FIG. 2 schematically illustrates a device (20) for optimizing plant root-zone temperature that comprises an add-on unit adapted to control the irrigation water temperature to optimize the root-zone temperature, according to an embodiment of the invention. Device (20) is a combination of the elements of device (10) that are included the well-isolated body (100) with an add-on unit that is configured to control the irrigation water temperature. In this embodiment, device (20) comprises device (10), a possibly replaceable gaseous CO₂ liquidation unit (150), a possibly replaceable compressor unit (151), a possibly replaceable liquid CO2 container (152), a bypass pipe for irrigation water (163), a replaceable warm irrigation water generator unit (160) located within well-isolated body (100). In this figure, a replaceable warm irrigation water generator unit (160) is shown after being removed out of body (100). According to this embodiment, replaceable compressor unit (151) and replaceable liquid CO2 container (152) can be located within replaceable gaseous CO₂ liquidation unit (150), as schematically illustrates, in a semi-exploded view, in FIG. 2.

The operational switch and operation electronic board (140) activates the microvalve (120) to release an amount of the liquid CO₂, to start the expenditure process, followed by a sublimation reaction, the released amount is very flexible and finely controlled, in accordance with the desired amount of the cool fluid, such as cool air in outlet (122). Battery (141) enables the operation of the different components of device 20, such as mini valves, mini motors/pumps/blowers, and sensors.

According to an embodiment of the invention, device (20) can be connected to various irrigation systems as a root-zone cooling unit.

According to an embodiment of the invention, the device of the present invention may provide additional arrangements; for example, the liquid CO2 may be stored in an essentially cylindrical container inside body (100), having, for example, a volume of 1/20 or 1/10 of the total device volume, whereas a regulated valve releases a part of the compressed CO2 into the expansion space. The expansion space surrounding the heat exchanger, for example, in a double cone shape, is closely adjacent to the heat exchanger. Gaseous CO2, which lost a significant part of its cooling capacity, may be removed from the expansion space, preferably by absorbing in the liquidation unit.

According to an embodiment of the invention, a roots-zone temperature control device usually consists of four main spaces (chambers), two absorption units, valves and sensors, two blowers, regulation elements, and an insulating outer coat. As shown in FIG. 2

The chambers include a CO2 liquid container, expansion space, heat exchanger space, and mixing space; the absorption units include a CO2 gas liquidation unit; the valves are finely regulated and include a liquid CO2 release valve, safety pressure valve, and fluid stream regulating valves.

According to an embodiment of the invention, the device of the invention may be designed to comprise replaceable parts, including a gaseous CO₂ absorption unit for liquidation and recycling, a liquid CO2 container, or a battery.

As shown in FIG. 2, device (20) comprises an add-on unit adapted to control the irrigation water temperature to optimize the root-zone temperatures. According to an embodiment of the invention, the add-on unit is adapted for temperature control capacity, and it can be installed in a dedicated chamber within an enclosure of device (20), e.g., the enclosure can be provided as a well-isolated body, and can be taken to the field for immediate activation, if needed. Using such a device is a significant advantage, compared to the prior art, especially when taking into consideration the need for a root-zone temperature control treatment when facing climate instability that can cause long-term damages, which can be avoided or at least minimized if the roots-zone temperature of the plants is stabilized soon enough.

Water opening of the irrigation system is suitable to be coupled to the dedicated chamber containing the add-on unit of device (20), which can be provided in the form of type of a mechanical device that separates a compressed gas into hot and cold streams (e.g., in the form of a Ranque-Hilsch vortex tube, or shortly a vortex tube) that can be coupled to a water opening by an irrigation water entry opening. According to an embodiment of the invention, a connector comprises an irrigation inlet tube that can be connected to the water supply outlet tube. When the irrigation water supply is connected to the inlet tube, it allows the water to flow into the connector toward the entry opening and water outlet tube. It is also provided with an inner structure, such as the aforementioned vortex tube, which separates the water stream into hot and cold streams, the hot stream being directed toward the water opening of the irrigation system and the cold stream being exhausted and recycled, and if desired, partly used to reduce the temperature of the heat stream portion.

According to an embodiment of the invention, device (20) comprises a sensor that detects the desired temperature in the roots zone of the plants and signals a processor to allow water to flow from the cold stream and into the hot stream, e.g., by actuating a valve that regulates the flow of the exhausted cold water, and the processor can be a processor that is located within the device, or it can be an external processor that communicates with the device. Employing an external processor allows to simplify the device and reduces its size. Moreover, it allows upgrading the performance of the device as new and improved data analyzers become available, with more robust data accumulations. Suitable software can be provided on the external processor, to operate the device, and in the case of data accumulation, an application can be used.

According to an embodiment of the invention, to monitor the roots-zone temperature throughout the farming process, device (20) can be further provided with a roots-zone temperature-measuring component and an indicator that will remind the irrigation operator to measure the roots-zone temperature of the farming units. Measuring roots-zone temperature throughout the process is essential to determine the necessary flow rate and duration of the process, since an overheating of the roots can also cause damage.

According to an embodiment of the invention, the temperature of the exhaust cold water can be set as a reference point and can be used to calculate the regulator of the vortex tube, when taking into consideration physical indicators, such as the temperature and the humidity of the ambient air.

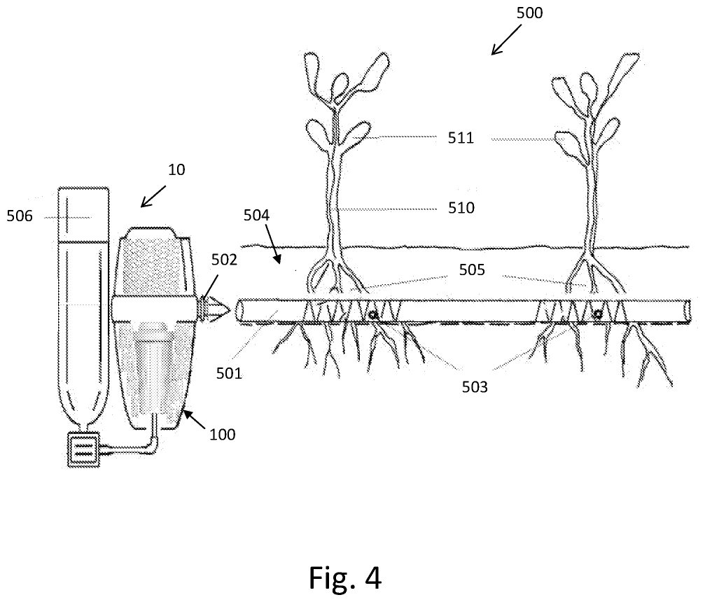

FIG. 4 schematically illustrates an implementation of a farming Vernalization system (500), according to an embodiment of the invention. According to the farming Vernalization embodiments of the invention, a cooling device may look as device (10) of FIG. 1. The system (500) may comprise a well-isolated device body (100), an interface (502) into the irrigation pipes system (501) constituting an irrigation pipe as a heat exchanger with the farming substrate (504). The pipes (501) may comprise a fine low flow outlet (503), in one embodiment, deployed along its whole length, possibly in the undersurface deployment. The cold air exchanges cooling energy with the farming substrate (504) and is released into the roots-zone (505) of the plants (510). The invention provides additional arrangements; for example, the gaseous CO₂ (506) may reach the atmosphere for the plants for a more efficient photosynthesis process in the green plant's organs (511).

Additionally, the air humidity that is frozen in the device's heat exchanger is defrizzed in the proses and released into the irrigation system, providing part of the farming essential irrigation water supply for the plants.

Importantly, the present invention provides a novel root-zone temperature control device for different farming procedures, which is surprisingly compact, robust, easily scalable to any needed size, and works autonomously without an external power supply or coolant supply; the device can be efficiently employed in agricultural applications, even under the most complex field conditions. Thus, a temperature control system is provided without a closed heat pump cycle or an external power supply.

For example, the present invention can be implemented as a method that provides a way to cool and disinfect agricultural yield products (such as fruits and vegetables) by regulating and controlling their temperature using cool air and CO2 gas. This process may occur during harvesting in boxes or palettes or crates and does not require a closed refrigeration cycle or external power supply. This method may involve using at least four chambers: one containing liquid CO2 that is expanded to a second chamber through a micro circumferential nozzle, a third chamber driven by a blower to cool the air through an inlet and outlet, and a fourth chamber driven by cold air line pressure to cool the harvested products through an inlet and outlet. A sensor measures the temperature of the harvested products, and a microprocessor with data and software receives signals from the sensor and sends instructions to the valve and blower to provide cold air or CO2 treatment to the harvested products. The cooling process can occur once or multiple times during separate events, and the temperature can be reduced from ambient temperature by 2-20° C. The cold air stream can have a magnitude of between 0.1-100 l/min.

While the invention has been described using some specific examples, many modifications and variations are possible. Therefore, it is understood that the invention is not intended to be limited in any way, other than by the scope of the appended claims.

1-31. (canceled)

32. A device for optimizing the temperature of a plant's root zone by generating and delivering controlled streams of fluid via an irrigation system, comprising:
a pressurized chamber containing liquid CO₂;
an expansion chamber adapted to receive liquid CO₂ from the pressurized chamber to change CO₂ phases into gas and solid;
a first valve controlling the release of CO₂ into the expansion chamber via micro circumferential nozzles, producing a cooling effect;
a heat exchanger chamber in conductive contact with the pressurized and expansion chambers, cooling fluid directed through an inlet and outlet;
a pump for circulating fluid through the heat exchanger chamber to the plant root zone; and
a processing unit configured to receive temperature measurements of the root zone and adjust fluid flow and temperature in response.

33. The device of claim 32, further comprising a sensor for measuring temperature at the root zone and a flow rate sensor measuring the fluid's flow rate at the outlet.

34. The device of claim 32, further comprising a CO₂ recycling unit with a compressor, directing exhausted CO₂ gas back into the pressurized chamber as liquid.

35. The device of claim 32, wherein the heat exchanger is equipped with a conductive mesh structure to maximize heat transfer efficiency.

36. The device of claim 32, further comprising a battery to power the pump, valve, processing unit, and sensors, allowing autonomous operation.

37. The device of claim 32, wherein the processing unit is programmed with data to regulate the root zone temperature and fluid flow based on received sensor data and predefined temperature settings.

38. The device of claim 32, wherein the device includes an interface for connection to an irrigation system, allowing integration into existing agricultural infrastructure.

39. The device of claim 38, further comprising a vortex tube to modulate the temperature of irrigation water, with a second valve to control water temperature delivered to the root zone.

40. A method for controlling root-zone temperature in plants, comprising:
providing a device with a first chamber containing liquid CO₂ in a pressurized form;
releasing CO₂ from the first chamber into an expansion chamber via a microvalve and micro nozzles, creating a cooling effect by changing CO₂ phases into gas and solid;
circulating fluid through a heat exchanger chamber and delivering it to the root zone;
receiving temperature data from at least one sensor at the root zone; and
using a processing unit to adjust CO₂ release and fluid flow based on the temperature data.

41. The method of claim 40, further comprising adjusting the flow rate and cooling duration to accumulate chill hours in the root zone as needed for plant development.

42. The method of claim 40, wherein the fluid has a controlled temperature between −75° C. and +35° C., and the flow rate is between 0.1 and 100 l/min.

43. The method of claim 40, further comprising integrating the device into an irrigation system, allowing fluid delivery through standard irrigation infrastructure.

44. The method of claim 40, further comprising recycling exhausted CO₂ through a compressor to maintain liquid CO₂ in the pressurized chamber.

45. The method of claim 40, wherein the device autonomously regulates temperature adjustments based on pre-set chill hour requirements for specific crop types.

46. A compact, autonomous temperature control device for agricultural applications, comprising:
a CO₂-based cooling system with a heat exchanger, expansion chamber, and recycling unit;
sensors to measure root zone temperature and flow rate;
a processing unit to control CO₂ release and fluid flow; and
a beat-insulating enclosure for prolonged storage and operation under various field conditions.
